(19) United States
(12) Patent Application Publication
(10) Pub. No.: US 2024/0411951 A1
(43) Pub. Date: Dec. 12, 2024

(54) WELLBORE CLEAN-UP APPARATUS AND METHOD

(71) Applicant: Schlumberger Technology Corporation, Sugar Land, TX (US)

(72) Inventors: Kashif Rashid, Wayland, MA (US); William Bailey, Somerville, MA (US); Bertrand Theuveny, Paris (FR)

(21) Appl. No.: 18/333,313

(22) Filed: Jun. 12, 2023

(51) Int. Cl. G06F 30/20

(52) U.S. Cl. CPC G06F 30/20; G06F 2113/08

(57) ABSTRACT

Embodiments presented provide for a clean-up apparatus and method for wellbore environments. In embodiments, a design for wellbore clean-up is chosen and then the design is modeled to perform operations on the wellbore and produce results related to an efficiency of clean-up and time to achieve this clean-up. The design may be optimized during the analysis.

### CROSS-REFERENCE TO RELATED APPLICATIONS

None.

### FIELD OF THE DISCLOSURE

Aspects of the disclosure relate to wellbore clean-up activities. More specifically, aspects of the disclosure relate to providing optimal clean-up activities for a wellbore intended to produce hydrocarbons.

### BACKGROUND

Wellbore cleanup activities are an essential part of hydrocarbon recovery operations. Wellbore cleanup activities provide for removal of fluids and or other materials from a wellbore. The overall objective of these activities is to provide a wellbore clear of contaminants so further processing may occur. Wellbore cleanup activities can include pumping materials from the wellbore, in one example embodiment. The contaminants in a wellbore may be liquids, such as mixtures of water and processing chemicals during the drilling process.

Conventionally, hydrocarbon operators merely try to pump materials from the wellbore. Such pumping; however, cannot be undertaken without potential problems. In some wellbores, simple pumping from the wellbore will cause fines at the bottom of the wellbore to loosen if the amount of fluid removed exceeds a threshold limit. In such wells, pumping large amounts of fluid can cause wellbore degradation. For example, a large amount of fines in the surrounding geological formation may be dislodged when friction forces keeping the fines in place are exceeded by the drag forces induced by the flowing fluid from the geological stratum into the wellbore. Such fines may be present within the formation or may have entered the formation through the drilling process.

Wellbore degradation is a fairly well understood process; therefore, measures are put in place to minimize the fines dislodged during fluid removal operations. As can be expected, velocities of the fluid traveling into the wellbore are kept at levels that prevent the drag forces from overcoming the frictional forces. Since fluid is generally incompressible, by closing the top exit of the wellbore, the amount of fluid escaping from the wellbore is minimized and the velocities of the fluid is decreased. To effectuate this process, engineers have a “choke” schedule, wherein the exit of the wellbore is closed and opened during certain times, establishing flow and stopping flow. For definitional purposes, the term “opened” may include any percentage of a totally open (100%) configuration. Additionally, the term “fluids” may include pure fluids or slurries.

It is desired to clean the wellbore of fluids other than hydrocarbons in a quick and efficient manner to speed overall production. Conventional methods are conservative in their approach in order to eliminate a wellbore collapse; therefore, wellbore fluid withdrawal may take significant amounts of time.

There is a need to provide apparatus and methods that are easy to operate for field personnel.

There is a further need to provide apparatus and methods that do not have the drawbacks discussed above, namely wellbore cave in or dislodgement of fines from the geological stratum.

There is a still further need to reduce economic costs associated with operations and apparatus described above with conventional tools and to speed overall production of the wellbore.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are; therefore, not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a method for wellbore clean-up is disclosed. The method may comprise inputting data related to a design for clean-up of the wellbore and inputting data related to the wellbore into a computer arrangement. The method may also comprise evaluating a response for the design for the inputting of the data related to the wellbore into the computer arrangement to generate results. The method may also comprise outputting the results to output files. The method may also comprise evaluating the output files through the use of an evaluator, wherein the evaluator generates an objective measure of interest. The method may also comprise optimizing the design for clean-up of the wellbore. The method may also comprise creating a new design for clean-up of the wellbore based at least in part on the optimizing of the design.

In another example embodiment, an article of manufacture is disclosed. The article of manufacture may comprise a non-volatile memory and wherein the article of manufacture includes a set of instructions that are capable of being read by a computing apparatus, the set of instructions configured with a method for wellbore clean-up. The method for wellbore clean-up may comprise inputting data related to a design for clean-up of the wellbore and inputting data related to the wellbore into a computer arrangement. The method may further comprise evaluating a response for the design for the inputting of the data related to the wellbore into the computer arrangement to generate results. The method may also comprise outputting the results to output files. The method may also comprise evaluating the output files through the use of an evaluator, wherein the evaluator generates an objective measure of interest. The method may also comprise optimizing the design for clean-up of the wellbore. The method may also comprise creating a new design for clean-up of the wellbore based at least in part on the optimizing of the design.

In another example a method for wellbore clean-up is disclosed. The method may comprise inputting data related to a design for clean-up of the wellbore into a computer arrangement, wherein the data includes clean-up equipment efficiency and availability. The method may further comprise inputting data related to the wellbore into the computer arrangement. The method may further comprise performing evaluations of clean-up efficiency and time of clean-up calculations for the design to generate results. The method may further comprise outputting the results to output files. The method may also provide for evaluating the output files through the use of an evaluator, wherein the evaluator generates an objective measure of interest. The method may also provide for optimizing the design for clean-up of the wellbore. The method may also provide for creating a new design for clean-up of the wellbore based at least in part on the optimizing of the design.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted; however, that the appended drawings illustrate only typical embodiments of this disclosure and are; therefore, not be considered limiting of its scope, for the disclosure may admit to other equally effective embodiments.

FIG. 1 is a schematic design of the proposed workflow for wellbore clean-up optimization.

FIG. 2 is a graph of a clean-up measure as a function of time.

FIG. 3 is method for wellbore clean-up optimization in one example embodiment of the disclosure.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood; however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, components, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Aspects of the disclosure provide for a method to achieve clean-up of a wellbore in an efficient manner. Embodiments of the method may include a computing engine that is configured to establish an optimal removal of fluids from a wellbore. The fluids removed from the wellbore may be processing fluids and/or water that have accumulated or that have been used in the creation of the wellbore. As will be apparent, these non-hydrocarbon-based fluids should be removed prior to production of the downhole hydrocarbons.

Some embodiments will now be described with reference to the figures. Like elements in the various figures will be referenced with like numbers for consistency. In the following description, numerous details are set forth to provide an understanding of various embodiments and/or features. It will be understood; however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

In embodiments, the method presented describes an optimal clean-up procedure for a well infiltrated with mud and filtrate at the outset of a clean-up procedure that is modeled using a simulation process. The mud may be a drilling fluid, for example, that is used in the construction of the well. Such drilling fluids may be used for wellbore stabilization, wellbore construction and/or wellbore stimulation. In some instances, water or a brine solution may also be used in the wellbore construction. Thus, water may enter through not only geological creep but also through intentional use to clean the wellbore of heavy debris. Once the heavy debris is dislodged, the water may remain, necessitating clean-up activities.

Once the water and non-hydrocarbon fluids are removed from the wellbore, these fluids are then treated to prevent environmental contamination. The treatment may be by pumping the fluids into a sedimentation pond where sediment is allowed to settle. After settlement, the fluids may be treated with chemicals on-site or the fluids may be pumped into a tanker truck which removes the fluids for eventual clean-up at an industrial facility.

In these embodiments, two parameters are attempted to be optimized for operations. The first parameter that is attempted to be optimized is time. As will be understood, if time is minimized for clean-up operations, then production of hydrocarbons can commence. This leads to greater overall efficiency. The second parameter that is attempted to be optimized is clean-up efficiency. In embodiments, the clean-up efficiency is provided on a percentage basis compared to a totally clean wellbore. It is desired to have very high clean-up efficiency rates as there is a need to produce very high-quality hydrocarbons at the wellbore source. As will be understood, the optimization of the time value may indicate the point at which the systems are at specific configurations, such as open, closed or partially opened valves.

In one embodiment, the geometric parameters of the wellbore and the surrounding geological stratum are input into a computing arrangement. Based upon the entry of the data, an optimizer may create a choke schedule for the well. This choke schedule is plotted over time to ensure that deleterious conditions do not impact the wellbore. In some applications, the wellbore may be under pressure wherein a natural flow of fluids will occur upon the opening of the wellbore. In some embodiments, where the hydrostatic pressure is not sufficient to lift fluids to the surface, other methods may be used for removal of fluids. One such method is to use artificial lift, wherein pumping occurs creating a hydrostatic head, allowing flow of the fluids.

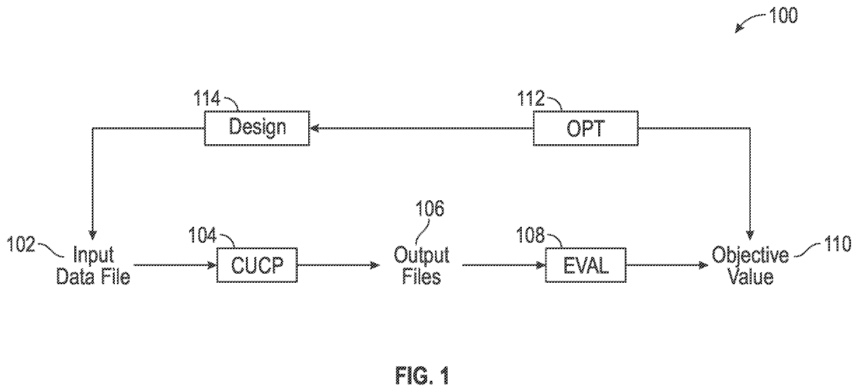

Referring to FIG. 1, a schematic design for wellbore clean-up optimization is illustrated. The overall arrangement 100 allows for accomplishing wellbore clean-up quickly and efficiently. At 102, data is obtained and placed into a computer arrangement through an input data file. In example embodiments, the input data file 102 may include features of the wellbore and surrounding geological stratum. Such features may include, but not be limited to, the length of the wellbore, the width of the wellbore, the thickness of the casing/piping, the types and thicknesses of geological stratum that the wellbore penetrates, the anticipated hydraulic head within any potential hydrocarbon fields located near the wellbore, the type of completion technology used, the anticipated amount of fluids to be removed from the wellbore that are other than hydrocarbon based, the types of pumps or fluid removal technologies to be used, the molecular weight/density of the fluids within the wellbore and an anticipated choke schedule for release of fluids from the wellbore. Other similar values may also be input. This data is used for calculation purposes by a 104 CUCP near-wellbore simulator). The 104 CUCP simulator, is used to evaluate the choke schedule response for a given model or design that has been chosen (types of pumps for example) that will be used to remove the required fluids. The calculations are output from the CUCP simulator 104 to output files 106. These output files 106 are then evaluated by an evaluator 108. The evaluator 108 generates an objective measure of interest (i.e. it is used to evaluate several metrics of interest and then returns one particular measure as the desired objective measure as selected by the decision maker. These objective values are then compared to the stated goal of the project. The objective values may be, for example, the amount of time that it will take to perform a clean-up of the wellbore. A further objective value may be the percentage of cleanup that is possible with the design chosen. For example, certain types of pumps may have a limited capacity and therefore, the total percentage of potential clean-up may be low compared to a higher horsepower pumping unit. For this reason, it may be necessary to change the overall design for the removal system to achieve a higher percentage of clean-up. An optimization program 112 is then run to alter the type of components in the overall design 114, which generates the design (choke schedule) given the parameterized control set from the optimization program 112. The design 114 characteristics, being updated by the optimization program 112, are updated into a new input data file 102. The process then begins anew. In the design 114, ramping and/or smoothing operations may be performed. The ramping and/or smoothing operations may be used to expand and smooth the resulting choke schedule. As will be understood, constraints may be used in the analysis. Constraints may be stipulated for different values or metrics. Constraints may be, for example, placed on choke changes with time or regarding temporal or cumulative production limits for liquid, oil, water and gas. In some embodiments, an alternative to the optimization program 112 may be to run many evaluations in parallel using cloud-computing and then to pick one or more desirable candidates directly.

In embodiments, the output from the evaluator 108 may be tabulated for review by operators. Based upon the most important factor, as determined by operators, a design may be chosen that provides the best design to achieve the factor chosen. For example, it may be desired that the amount of time that it takes to perform a clean-up of a wellbore may range from 2 hours to 6 hours. For these scenarios, it may also be determined that the average clean-up ratio only varies slightly from 99.2 percent to 99.7 percent. In this type of scenario, the design according to the 2 hour clean-up is chosen as the average clean-up ratio varies only a slight amount.

In other scenarios, the clean-up ratio may be much more important. In a second wellbore, the average clean-up time may extend 2 hours to 6 hours, but the 2 hour clean-up time only has a 85 percent efficiency. The 6 hour clean-up time may lead to a 99 percent efficiency. If the 85 percent efficiency is not above a threshold amount set by operators, then the design pertaining to this clean-up time would be discarded as the objective value resulting from the calculations does not meet the required criteria.

In embodiments, the evaluator 108 may be located on a separate computing arrangement such as a cloud-computing arrangement. In still further embodiments, the evaluator 108 may be a sub-program of other calculation portions of a program. In embodiments where all of the calculation responsibilities are performed by a single program, the single program may be configured on a non-volatile memory. Examples of a non-volatile memory may be a compact disk, a universal serial bus device (USB), a computer hard disk or a solid-state memory arrangement.

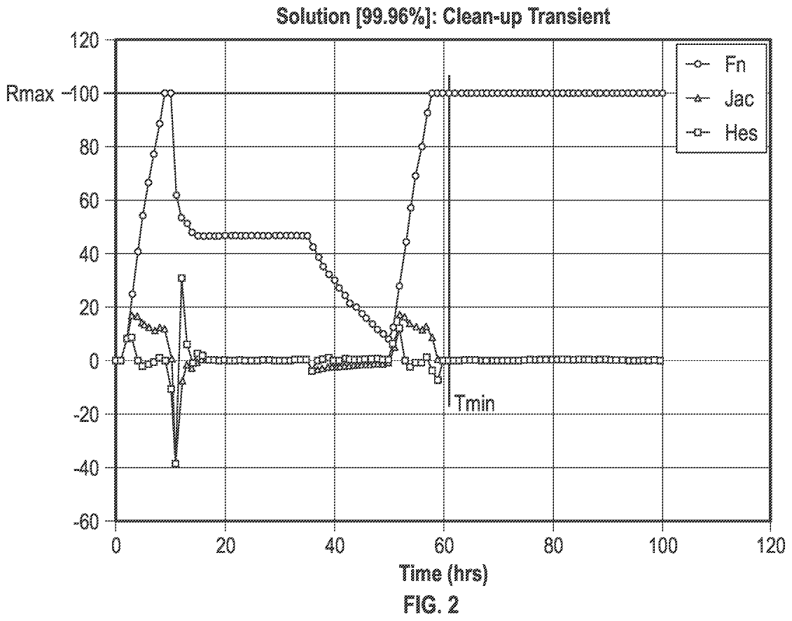

The output files 106 generated are analyzed and a clean-up measure is established as a function of time, in one embodiment. This information is used to infer the highest stable clean-up that was achieved together with the time required. Several objective measures can be accommodated, including best clean-up, minimum time or some combination thereof. The optimizer provides an updated design that is converted into a suitable schedule and inserted into the input data file required to run the simulation model (as given above). The procedure thus repeats, according to the adaptive optimization scheme employed, until convergence. In embodiments, a derivative free method may be used. In some embodiments, a Hessian matrix may be used, different than the Hessian profile referred to in FIG. 2. As will be understood, a multi-objective optimization for wellbore clean-up with least time per the design 114 and the evaluator 108 portions. The evaluator 108 may be used to infer the solution point of each design, as illustrated in FIG. 2.

Referring to FIG. 2, a graph of levels of clean-up achieved by the apparatus chosen by the method are illustrated. In this embodiment, the blue curve indicates the level of clean-up achieved at any given time over the course of the simulation run. The orange and grey curves indicate the first and second order sensitivity information, respectively. The first order information is referred to as the Jacobian, and the second order as the Hessian. The Hessian information is used to infer the stable convergent point. This is noted as the intersecting point given by the two red lines in the figure above, with the x-axis marker Tmin and y-axis marker Rmax. These items refer to the least time and highest clean-up measure identified, respectively. Hence, any choke schedule impressed on the simulation model of the wellbore, will result in a clean-up profile as one shown above. Thus, the choke schedule can be tuned (optimized) to maximize the level of clean-up possible while minimizing the time required to do so.

Vector calculus may be used in calculations. In vector calculus, a Jacobian matrix of a vector-valued function of several variables is the matrix of all its first-order partial derivatives. The Hessian matrix is a square matrix of second-order partial derivatives of a scalar-valued function or scalar field. It describes the local curvature of a function with many variables.

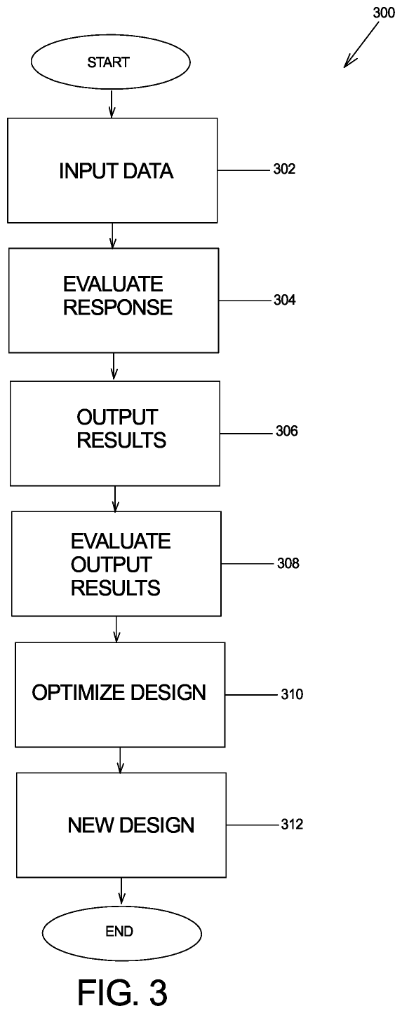

Referring to FIG. 3, a method in conformance with one example embodiment of the disclosure is presented. The method disclosed may be altered by a person of skill in the art to achieve different results, as necessary. A method 300 for wellbore clean-up is disclosed. The method 300 may comprise, at 302, inputting data related to a design for clean-up of the wellbore and inputting data related to the wellbore into a computer arrangement. The method may also comprise, at 304, evaluating a response for the design for the inputting of the data related to the wellbore into the computer arrangement to generate results. The method may also comprise, at 306, outputting the results to output files. The method may also comprise, at 308, evaluating the output files through the use of an evaluator, wherein the evaluating compares the results to objective values. The method may also comprise, at 310, optimizing the design for clean-up of the wellbore. The method may also comprise, at 312, creating a new design for clean-up of the wellbore based at least in part on the optimizing of the design. In embodiments, the method may be performed wherein the inputting of the data related to the wellbore, at 302, includes at least one of a length of the wellbore, a width of the wellbore, a thickness of a casing of the wellbore, an anticipated amount of fluids for removal, and a density of the fluids for removal. In further embodiments, the method may be performed, at 302, wherein the inputting of the data related to the wellbore includes a choke schedule for opening and closing of the wellbore. In further embodiments, the method may be performed wherein the evaluating the response for the design, at 304, is related to a choke schedule for the design. In another example embodiment, the method may be performed wherein the creating the new design for clean-up of the wellbore, at 312, is based at least in part on the optimizing of the design including creating input data for a new design as optimized. As will be understood, the method 300 may further comprise visually depicting results of the optimized design. Other possibilities include creating a spreadsheet listing the results of analysis. The best possible alternatives for analysis may be highlighted for operator review. In another example embodiment, the method 300 may further comprise running the method to develop at least two optimized designs and then displaying at least one of a time of clean-up and a clean-up efficiency for each of the optimized designs. As will be understood, calculations may take place on a personal computer or in a cloud computing arrangement. Iterative computations may occur for creation of several designs for wellbore clean-up. In embodiments, a database of available clean-up components used in designs may be accessed for providing many options for analysis. In some embodiments, cost efficiency may also be determined. As will be understood, while a certain design may be extremely efficient at performing the project and the time for completing the project may be small, the overall result may be unsatisfactory as the mobilization of such equipment may be cost prohibitive. In some instances, there may also be other factors, such as the inability of specific field personnel to be able to run the necessary components of a design. In such embodiments; therefore, a design may be efficient at cleaning, the components may be available and the overall cost may be kept to a minimum. If operators are not available to run the equipment, the design must fail as a possible choice due to safety concerns. While not discussed above, these features may be part of the inputting process to help in decision making.

Other computer programs may be used performing calculations to make the overall selection more efficient. Original designs for input may be contained in databases for reference to make initial selections. Cleaning efficiency and time factors may also be used to provide an initial design that is efficient within the near past to help calculation efficiency. In further embodiments, the methods employed may be interconnected with databases, such as operations databases, to provide designs based upon availability of equipment so that not only equipment is effectively chosen, but also the equipment is available for use. In some aspects, these methods may also interact with maintenance tracking programs for components. As will be understood, equipment used in such wellbore environments must undergo inspection and maintenance from time to time. Thus, if the chosen wellbore clean-up apparatus chosen is scheduled for maintenance, such equipment is not available for a period of time, thus obviating the use of this design. Conventional methods do not help in selection of wellbore clean-up apparatus and corresponding optimization, as well as interacting with maintenance schedules.

Embodiments of the disclosure and claims will now be discussed. The embodiments discussed should not be considered limiting. In one example embodiment, a method for wellbore clean-up is disclosed. The method may comprise inputting data related to a design for clean-up of the wellbore and inputting data related to the wellbore into a computer arrangement. The method may also comprise evaluating a response for the design for the inputting of the data related to the wellbore into the computer arrangement to generate results. The method may also comprise outputting the results to output files. The method may also comprise evaluating the output files through the use of an evaluator, wherein the evaluator generates an objective measure of interest. The method may also comprise optimizing the design for clean-up of the wellbore. The method may also comprise creating a new design for clean-up of the wellbore based at least in part on the optimizing of the design.

In another example embodiment, the method may be performed wherein the inputting of the data related to the wellbore includes at least one of a length of the wellbore, a width of the wellbore, a thickness of a casing of the wellbore, an anticipated amount of fluids for removal, and a density of the fluids for removal.

In another example embodiment, the method may be performed wherein the inputting of the data related to the wellbore includes a choke schedule for opening and closing of the wellbore. As will be understood, the term opening and closing of the wellbore may include the opening, partial opening, and closing of the choke.

In another example embodiment, the method may be performed wherein the evaluating the response for the design is related to a choke schedule for the design.

In another example embodiment, the method may be performed wherein the creating the new design for clean-up of the wellbore based at least in part on the optimizing of the design includes creating input data for a new design as optimized.

In another example embodiment, the method may further comprise visually depicting results of the optimized design.

In another example embodiment, the method may further comprise running the method to develop at least two optimized designs and then displaying at least one of a time of clean-up and a clean-up efficiency for each of the optimized designs.

In another example embodiment, an article of manufacture is disclosed. The article of manufacture may comprise a non-volatile memory and wherein the article of manufacture including a set of instructions that are capable of being read by a computing apparatus, the set of instructions configured, with a method for wellbore clean-up. The method for wellbore clean-up may comprise inputting data related to a design for clean-up of the wellbore and inputting data related to the wellbore into a computer arrangement. The method may further comprise evaluating a response for the design for the inputting of the data related to the wellbore into the computer arrangement to generate results. The method may also comprise outputting the results to output files. The method may also comprise evaluating the output files through the use of an evaluator, wherein the evaluator generates an objective measure of interest. The method may also comprise optimizing the design for clean-up of the wellbore. The method may also comprise creating a new design for clean-up of the wellbore based at least in part on the optimizing of the design.

In another example embodiment, the article of manufacture may be configured wherein the method for wellbore clean-up contained there may be performed wherein the inputting of the data related to the wellbore includes at least one of a length of the wellbore, a width of the wellbore, a thickness of a casing of the wellbore, an anticipated amount of fluids for removal, and a density of the fluids for removal.

In another example embodiment, the article of manufacture may be configured wherein the method for wellbore clean-up contained there may be performed the inputting of the data related to the wellbore includes a choke schedule for opening and closing of the wellbore.

In another example embodiment, the article of manufacture may be configured wherein the method for wellbore clean-up contained there may be performed the evaluating the response for the design is related to a choke schedule for the design.

In another example embodiment, the article of manufacture may be configured wherein the method for wellbore clean-up contained there may be performed the creating the new design for clean-up of the wellbore based at least in part on the optimizing of the design includes creating input data for a new design as optimized.

In another example embodiment, the article of manufacture may be configured wherein the method for wellbore clean-up contained there may further comprise visually depicting results of the optimized design.

In another example embodiment, the article of manufacture may be configured wherein the method for wellbore clean-up contained there may further comprise running the method to develop at least two optimized designs and then displaying at least one of a time of clean-up and a clean-up efficiency for each of the optimized designs.

In another example a method for wellbore clean-up is disclosed. The method may comprise inputting data related to a design for clean-up of the wellbore into a computer arrangement, wherein the data includes clean-up equipment efficiency and availability. The method may further comprise inputting data related to the wellbore into the computer arrangement. The method may further comprise performing evaluations clean-up efficiency and time of clean-up calculations for the design to generate results. The method may further comprise outputting the results to output files. The method may also provide for evaluating the output files through the use of an evaluator, wherein the evaluator generates an objective measure of interest. The method may also provide for optimizing the design for clean-up of the wellbore. The method may also provide for creating a new design for clean-up of the wellbore based at least in part on the optimizing of the design.

In another example embodiment, the method may be performed where the inputting of the data related to the wellbore includes a choke schedule for opening and closing of the wellbore. As will be understood, the term opening and closing of the wellbore may include the opening, partial opening, and closing of the choke.

In another example embodiment, the method may further comprise saving the new design into a non-volatile memory.

In another example embodiment, the method may further comprise running the method to develop at least two optimized designs and then displaying at least one of a time of clean-up and a clean-up efficiency for each of the optimized designs.

In another example embodiment, the method may further comprise saving the new design into a non-volatile memory.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method for wellbore clean-up, comprising:
inputting data related to a design for clean-up of the wellbore;
inputting data related to the wellbore into a computer arrangement;
evaluating a response for the design for the inputting of the data related to the wellbore into the computer arrangement to generate results;
outputting the results to output files;
evaluating the output files through the use of an evaluator, wherein the evaluating generates an objective measure of interest;
optimizing the design for clean-up of the wellbore; and
creating a new design for clean-up of the wellbore based at least in part on the optimizing of the design.

2. The method according to claim 1, wherein the inputting of the data related to the wellbore includes at least one of a length of the wellbore, a width of the wellbore, a thickness of a casing of the wellbore, an anticipated amount of fluids for removal, and a density of the fluids for removal.

3. The method according to claim 1, where the inputting of the data related to the wellbore includes a choke schedule for opening and closing of the wellbore.

4. The method according to claim 1, wherein the evaluating the response for the design is related to a choke schedule for the design.

5. The method according to claim 1, wherein the creating the new design for clean-up of the wellbore based at least in part on the optimizing of the design includes creating input data for a new design as optimized.

6. The method according to claim 1, further comprising visually depicting results of the optimized design.

7. The method according to claim 1, further comprising running the method to develop at least two optimized designs and then displaying at least one of a time of clean-up and a clean-up efficiency for each of the optimized designs.

8. An article of manufacture comprising a non-volatile memory, the article of manufacture including a set of instructions that are capable of being read by a computing apparatus, the set of instructions configured, with a method for wellbore clean-up, comprising:
inputting data related to a design for clean-up of the wellbore;
inputting data related to the wellbore into a computer arrangement;
evaluating a response for the design for the inputting of the data related to the wellbore into the computer arrangement to generate results;
outputting the results to output files;
evaluating the output files through the use of an evaluator, wherein the evaluating generates an objective measure of interest;
optimizing the design for clean-up of the wellbore; and
creating a new design for clean-up of the wellbore based at least in part on the optimizing of the design.

9. The article of manufacture according to claim 8, wherein the method for wellbore clean-up contained there may be performed wherein the inputting of the data related to the wellbore includes at least one of a length of the wellbore, a width of the wellbore, a thickness of a casing of the wellbore, an anticipated amount of fluids for removal, and a density of the fluids for removal.

10. The article of manufacture according to claim 8, wherein the method for wellbore clean-up contained therein may be performed the inputting of the data related to the wellbore includes a choke schedule for opening and closing of the wellbore.

11. The article of manufacture according to claim 8, wherein the method for wellbore clean-up contained therein may be performed the evaluating the response for the design is related to a choke schedule for the design.

12. The article of manufacture according to claim 8, wherein the method for wellbore clean-up contained therein may be performed the creating the new design for clean-up of the wellbore based at least in part on the optimizing of the design includes creating input data for a new design as optimized.

13. The article of manufacture according to claim 8, wherein the method for wellbore clean-up contained there may further comprise visually depicting results of the optimized design.

14. The article of manufacture according to claim 8, wherein the method for wellbore clean-up contained there may further comprise running the method to develop at least two optimized designs and then displaying at least one of a time of clean-up and a clean-up efficiency for each of the optimized designs.

15. The article of manufacture according to claim 8, wherein the article of manufacture is configured as one of a compact disk and a universal serial bus device.

16. A method for wellbore clean-up, comprising:
inputting data related to a design for clean-up of the wellbore into a computer arrangement, wherein the data includes clean-up equipment efficiency and availability;
inputting data related to the wellbore into the computer arrangement;
performing evaluations of clean-up efficiency and time of clean-up calculations for the design to generate results;
outputting the results to output files;
evaluating the output files through the use of an evaluator, wherein the evaluating generates an objective measure of interest;
optimizing the design for clean-up of the wellbore; and
creating a new design for clean-up of the wellbore based at least in part on the optimizing of the design.

17. The method according to claim 16, where the inputting of the data related to the wellbore includes a choke schedule for opening and closing of the wellbore.

18. The method according to claim 16, further comprising saving the new design into a non-volatile memory.

19. The method according to claim 16, further comprising running the method to develop at least two optimized designs and then displaying at least one of a time of clean-up and a clean-up efficiency for each of the optimized designs.

20. The method according to claim 19, further comprising saving the new design into a non-volatile memory.
